(19) United States
(12) Patent Application Publication
(10) Pub. No.: US 2026/0026512 A1
(43) Pub. Date: Jan. 29, 2026

(54) MACHINE FOR STRETCHING PIZZA DOUGH AND PREPARING DOUGH APPLICATIONS

(71) Applicant: HYPER FOOD ROBOTICS LTD., Tel-Aviv (IL)

(72) Inventors: Yariv Zvi RECHES, Ramat Gan (IL); Yehuda SHAMAI, Tel Aviv (IL); Harel David SHAFRAN, Nir Tzvi (IL)

(73) Assignee: HYPER FOOD ROBOTICS LTD., Tel-Aviv (IL)

(21) Appl. No.: 18/998,501

(22) PCT Filed: Jul. 27, 2023
(86) PCT No.: PCT/IL2023/050780

§ 371 Date: Jan. 26, 2025

Related U.S. Application Data
(60) Provisional application No. 63/392,875, filed on Jul. 28, 2022.

(51) Int. Cl. A21C 11/00; A21C 9/04; A21C 9/08

(52) U.S. Cl. CPC A21C 11/008; A21C 9/04; A21C 9/081

(57) ABSTRACT

A machine for stretching pizza dough, comprising a rotating tray configured to carry a plate with the pizza dough; a roller housing located above the rotating tray, said roller housing is coupled to rollers, wherein the rollers roll when being in physical contact with the pizza dough; a first actuator for rotating the rotating tray respective to the roller housing; a second actuator for adjusting a vertical distance between the roller housing and the rotating tray; a management system for controlling the operation of the first actuator and the second actuator according to a dough stretching plan.

### FIELD OF THE INVENTION

The present invention relates to an autonomous system for preparing food and methods for utilizing it.

### BACKGROUND OF THE INVENTION

Restaurants that serve pizzas and restaurant chains such as Pizza Hut, Domino's Pizza, and others serve millions of pizzas on a daily basis. Preparation of Pizza is time consuming and is done by employees of these restaurants. In addition to time, human labor sometimes results in inaccurate pizzas. Hence, there is a need for autonomous devices and machines for the preparation of pizzas.

### SUMMARY OF THE INVENTION

The subject matter discloses a machine for stretching pizza dough, comprising a rotating tray configured to carry a plate with the pizza dough; a roller housing located above the rotating tray, said roller housing is coupled to rollers, wherein the rollers roll when being in physical contact with the pizza dough; a first actuator for rotating the rotating tray respective to the roller housing; a second actuator for adjusting a vertical distance between the roller housing and the rotating tray; a management system for controlling the operation of the first actuator and the second actuator according to a dough stretching plan.

In some cases, the machine further comprises multiple roller housings having different sizes and a vertical axis, wherein the multiple roller housings are arranged around the vertical axis such that all the multiple roller housings can be placed above the rotating tray.

In some cases, the machine further comprises a placing module configured to place the pizza dough in a center of the plate. In some cases, the roller housing comprises an elastic layer capable of being in physical contact with the pizza dough. In some cases, the placing module comprises movable rollers in a bottom part of the plate.

In some cases, the roller housing has an upward position being remote from the rotating tray and a downward position in which the roller housing is in physical contact with the pizza dough. In some cases, the machine further comprises a flour container configured to store flour powder and a flour dispenser configured to dispense flour.

In some cases, the machine further comprises a brushing mechanism configured to create holes in the pizza dough, said brushing mechanism comprises a brush and an arm configured to move the brush on the dough. In some cases, the rotating tray comprises multiple sets of movable pins, each set is arranged in a different area of the rotating tray, said multiple sets enable securing plates of multiple sizes on the rotating tray.

In some cases, the machine further comprises an application station configured to prepare dough of unique shapes before transferring the dough to an oven. In some cases, the application station comprises a rotating axis such that the plate rotates when placed in the application station. In some cases, the application station comprises a dispenser for dispensing edible material onto the pizza dough. In some cases, the application station comprises a folding unit for folding the circumference of the pizza dough. In some cases, the application station comprises a folding unit for folding the circumference of the pizza dough with the cheese in it. In some cases, the application station comprises a cutter and a robotic arm used to turn the cut dough for creating dough bits around the center of the pizza dough. In some cases, the application station comprises multiple control arms and grippers for dough manipulation and crafting of the pizza dough. In some cases, the application station comprises a holding mechanism to stabilize the baking tray of the pizza dough.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a machine for stretching pizza dough, according to exemplary embodiments of the subject matter.

FIG. 2 shows a cross-sectional view of the machine for stretching dough, according to exemplary embodiments of the subject matter.

FIG. 3A shows a dough stretching machine with the plates and housing in an upward position, according to exemplary embodiments of the subject matter.

FIG. 3B shows a dough stretching machine with the plates and housing in a downward position, according to exemplary embodiments of the subject matter.

FIGS. 4A-4B show the plate rod pushing the upper plate to the downward position, according to exemplary embodiments of the subject matter.

FIG. 5 shows the housing placed on top of the baking dish, according to exemplary embodiments of the subject matter.

FIGS. 6-7 show rollers configured to roll above the dough, according to exemplary embodiments of the subject matter.

FIGS. 8-9 show the brushing mechanism, according to exemplary embodiments of the subject matter.

FIG. 10 shows a method for preparing pizza having a filled crust, according to exemplary embodiments of the subject matter.

FIG. 11 shows a method for preparing a “cheesy bites” type of pizza, according to exemplary embodiments of the subject matter.

FIG. 12 shows a method for preparing a “crown” type of pizza, according to exemplary embodiments of the subject matter.

FIG. 13 shows mechanical components for preparing pizza having a filled crust, according to exemplary embodiments of the subject matter.

FIG. 14 shows mechanical components for preparing a “cheesy bites” type of pizza, according to exemplary embodiments of the subject matter.

FIG. 15 shows mechanical components for preparing a “crown” type of pizza, according to exemplary embodiments of the subject matter.

FIG. 16 shows a general structure for an application station for creating applications for pizza, according to exemplary embodiments of the subject matter.

FIGS. 17A-17B show a machine for stretching pizza dough having multiple roller housings having different sizes, according to exemplary embodiments of the subject matter.

### DETAILED DESCRIPTION OF THE INVENTION

The term “autonomous” is defined in the subject matter as self-governing, that does not require persons to operate. This is different from automated, which performs a process, but still requires persons to operate it.

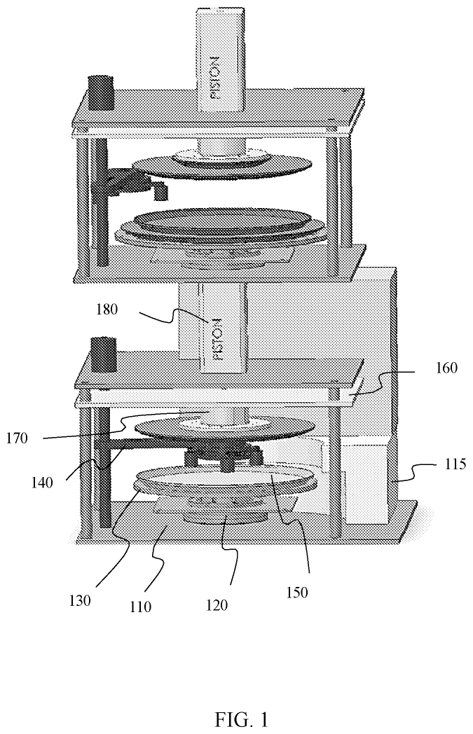

FIG. 1 shows a machine for stretching pizza dough, according to exemplary embodiments of the subject matter. The machine receives dough in a non-stretched form, meaning dough that is not ready for baking pizza in terms of the dough's form. For example, the dough's form may be a disk, a ball, or another form that is not ready for preparation of pizza, for example by being too high or too narrow. The output of the stretching machine is a stretched dough that fits the exact dough form requirements, i.e. thickness, diameter and so on, and covers a larger area on the plate on which the dough is placed.

An autonomous system of the subject matter may comprise multiple stretching machines, each can perform different stretching characteristics, i.e. thickness and diameter. For example, stacked one on top of the other or next to the other. Each of the stretching machines works independently from the others, for example by receiving separate commands from the management system of the autonomous system. Each of the stretching machines is coupled to a power source, such as a battery or power cable.

A stretching machine comprises a body for securing the stretching machine's components. The body may comprise a base 110 placed on the autonomous system's floor or on another surface, and additional walls or poles connecting elements of the machine to the body. The stretching machine comprises a rotating plate) the bottom tray 130. The rotating plate 130 rotates around an axis perpendicular to the base 110, or in a manner that keeps the dough in place. The rotation's duration and speed may vary based on the dough's weight or other properties. When stretching the dough, the rotation's speed may vary based on a predefined stretching plan. A plate 150 having the dough is configured to be mounted on top of the rotating plate 130, or on top of a pressing module located on the rotating plate 130. The dough is stretched using a centrifugal force applied on the dough due to the rotational movement of the rotating plate 130 on which the dough is placed.

The stretching machine comprises one or more pressing modules configured to apply energy to hold the dough. At least some of the energy is applied when the dough rotates on the rotating plate 130. The amount and duration of energy applied by the holder may vary during the stretching process of the dough. The holder 170 moves downwards towards the plate 10 carrying the dough using a pressing actuator. The holder 170 and the pressing actuator may be placed in a pressing housing 180. The stretching machine may comprise multiple holders of various sizes, to be able to press on doughs of various sizes. In some cases, the bottom part of the holders is different in size and the top part of the holder is the same, enabling to place the plate 150 regardless of the dough's size.

The holder 170 may be coupled to a pressing stabilizer 160. The pressing stabilizer 160 is coupled to the body of the stretching machine, for example by sliding along the body's legs, to maintain the pressing stabilizer 160 substantially parallel to the base 110. This way, the holder 170 remains parallel to the base 110 and presses the dough from a substantially perpendicular angle.

The stretching machine may comprise a machine 115 for preparing complicated dough applications, such as pizza with cheese in which at least part of the dough is filled with edible materials, such as cheese or some sort of sauce or dressing. In some cases, cheese fills the parts of the dough closer to the circumference.

The stretching machine may comprise a placing module 140 configured to place the dough in the center of the plate 150. The placing module 140 may comprise movable rollers in a bottom part of the plate 150. The placing module 140 comprises an arm for moving the rollers towards the plate and away from the plate, as needed. The rollers enable the placing module 140 to verify that the dough is in the center of the plate 150 while the plate rotates on the rotating plate 130.

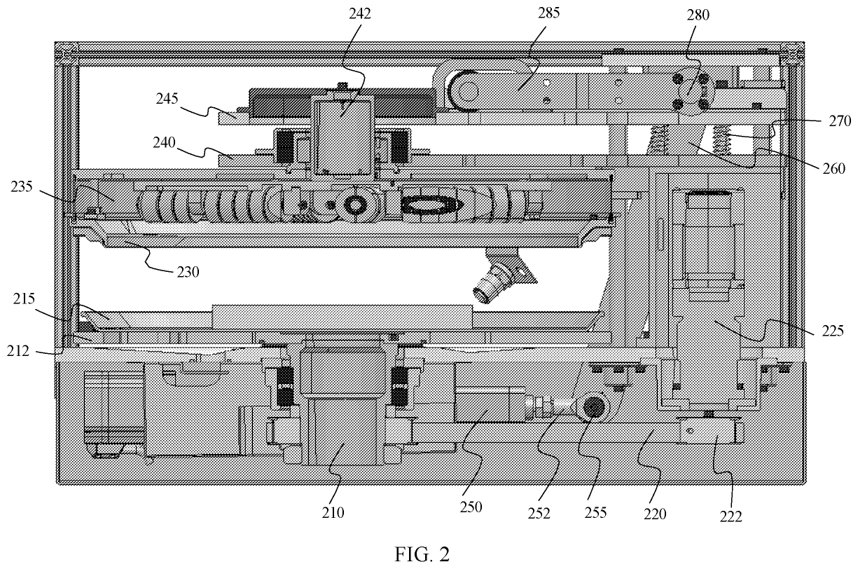

FIG. 2 shows a cross-sectional view of the machine for stretching dough, according to exemplary embodiments of the subject matter. The dough is provided to the machine in a non-stretched form, not ready for baking, and is outputted from the machine in a stretched state, ready for baking, or to be dispensed with cheese/dressing/additions and then to be baked.

The dough is placed on a baking dish 215. The baking dish 215 carrying the dough may be transferred into the machine when it already carries the dough, or the dough may be carried or transferred onto the baking dish 215, for example using a robotic arm.

The baking dish 215 is mounted on tray 212 in a manner that when the tray 212 moves rotationally, the baking dish 215 moves in the same direction and speed. In some cases, the baking dish 215 is secured to tray 212, for example using bolts or niches in the tray 212 or in the baking dish 215. The baking dish 215 may be removable from the tray 212, such that a new baking dish 215 is mounted on the tray when stretching a new piece of dough. The rotational movement of the baking dish 215 and the tray 212 is likely to be around an imaginary axis perpendicular to the ground. The tray 212 is coupled to a rotating axis 210 that rotates when a motor 225 transfers power thereto. The rotating axis 210 may be coupled to the tray 212 in an integral manner, for example as a single piece, or by screwing a screw extending from the axis 210 into the tray 212.

In some exemplary cases, the stretching machine comprises a flour container configured to store flour powder and a flour dispenser configured to dispense flour. The flour dispenser may be coupled to the flour container, for example via a pipe. The flour dispenser may be movable, for example using a robotic arm. The flour dispenser may dispense flour in response to a command from a management system of the stretching machine. For example, the flour dispenser may dispense flour onto the baking dish 215 before placing the dough onto the baking dish. The flour dispenser may also dispense flour onto the dough when placed on the baking dish 215, prior to the stretching process. The amount of flour dispensed in each time may vary based on properties such as baking dish size, type, size of the dough and the like. Dispensing may be done using an electro static mechanism, a pneumatic mechanism, an electronic mechanism and the like.

The motor 225 may be pneumatic, hydraulic, electronic or any other type of motor that can actuate an axis such as rotating axis 210. The motor 225 may receive power from a battery, from the electrical grid, or from another power source. The motor 225 may be coupled to the management system of the stretching machine, for example in order to receive commands on when to start and end power transmission to the rotation axis 210, the required rotational speed on a given time and the like. The motor 225 may transfer the power to the rotation axis via a power transmitter 222 coupled to the motor 225 and a strap 220. The strap may be in physical contact with the rotating axis 210, or with an intermediate object coupled to the rotating axis 210. This way, when the motor 225 generates power, the power is transferred from the motor 225 to the power transmitter 222, which results in the movement of the strap 220 which in turn generates movement of the rotating axis 210.

The stretching process is performed when rotating the baking dish 215 while applying force from above the dough. The force should be controlled to enable air to remain in the dough and the force is mainly to keep the dough in place. The force is applied by rollers 235 that move downwards towards the dough located on the baking dish. The rollers 235 roll around a horizontal axis coupled to the body of the machine. The horizontal axis does not move relative to the dough when the rollers 235 roll. The dough moves when the baking dish 215 rotates. The rollers 235 may be assembled by multiple sets of rollers, each set of rollers is coupled to another horizontal axis, as elaborated below. The rollers 235 may move downwards during the stretching process, for example in accordance with the height of the dough on the baking dish 215. The dough's height is reduced during the stretching process, and the rollers 235 move downwards to remain in contact with the dough.

When the stretching process begins, the baking dish 215 starts moving rotationally and the rollers 235 are required to move downwards. The rollers 235 may move downwards in tandem with an upper plate 245 coupled to the rollers 235. The upper plate 245 moves downwards in response to the movement of a piston 250 coupled to the body of the machine. The upper plate 245 and the rollers may be coupled via a rollers rod 242. The bottom plate 240 does not cover the entire cross-section of the upper plate 245, allowing room for the rollers rod 242 to slide upwards and downwards in tandem with the upper plate 245.

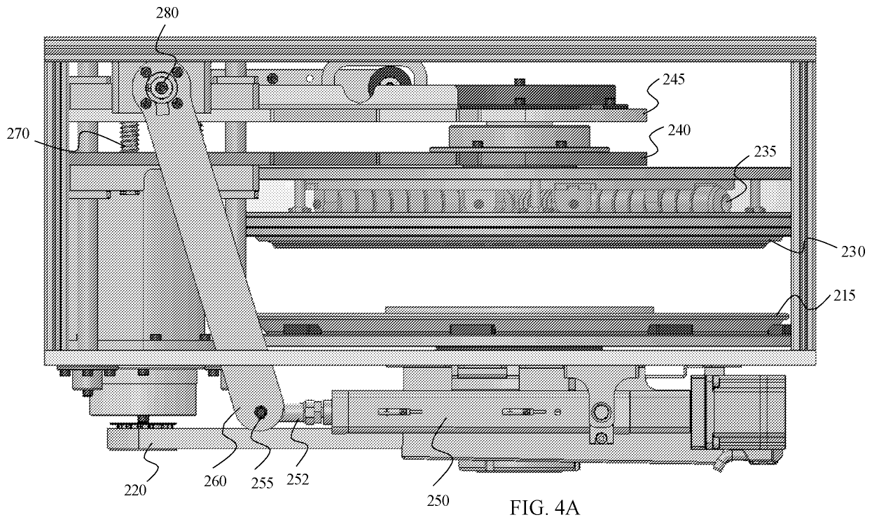

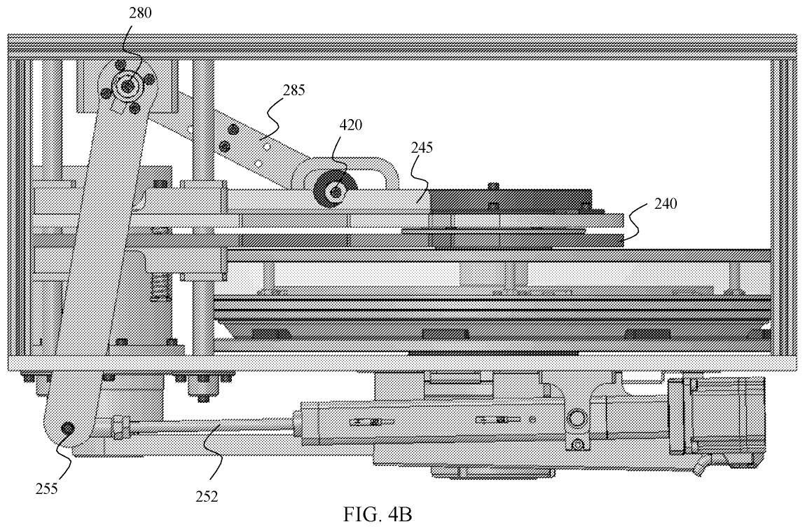

The piston module comprises a piston body 250, a piston rod 252 and a piston axis 255. The piston rod 252 moves inside the piston body 250 along a longitudinal axis of the piston body 250. The piston body 250 is of an elongated form. The piston axis 255 is coupled to a distal part of the piston rod 252, which is part of the piston rod located outside the piston body 250. When the piston module is in a closed state, the piston rod 252 is located mostly inside the piston body 250 and the piston axis 255 is relatively close to the piston body 250. The piston rod 252 is partially located inside the piston body 250 and moves outwards from the piston 250 when the piston 250 is in an open state. When the piston rod 252 moves outwards from the piston body 250, the piston axis 255 moves away from the piston body 250. That is, the distance between the piston axis 255 and the piston body 250 increases. The piston axis 255 is coupled to an operating rod 260 coupled to the upper plate 245. When the piston axis 255 moves away from the piston body 250, the distal end of the operating rod 260 moves towards the piston body 250 (on the horizontal axis only), causing movement of the upper plate downwards, as illustrated in FIGS. 4A and 4B.

The operating rod 260 is coupled to a plate axis 280 and a plate rod 285. The plate rod 285 is located on top of the upper plate 245, such that movement of the piston 250 pushes the plate rod 285 which in turn pushes the upper plate 245.

The movement of the operating rod 260 may further move the lower plate 240. The lower plate is coupled to housing 230 configured to limit the dough's stretching. The housing 230 moves downwards onto the baking dish 215 and rotates in response to the rotational movement of the baking dish 215. The housing 230 may be passive, such that it cannot move rotationally unless the housing is coupled to another object that moves rotationally. The housing 230 may be assembled of a rigid circle and an elastic layer placed inside the circle, for example, made of paper, silicon and the like, such that the elastic layer is in physical contact with the dough, and the rollers 235 roll over the elastic layer.

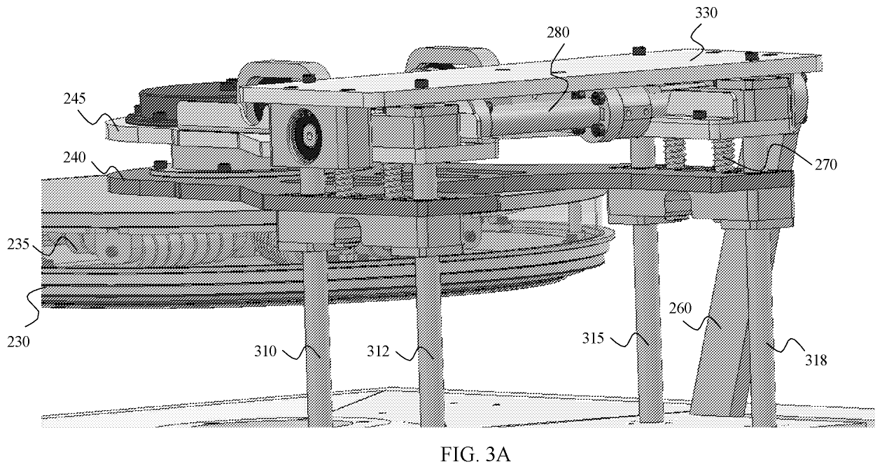

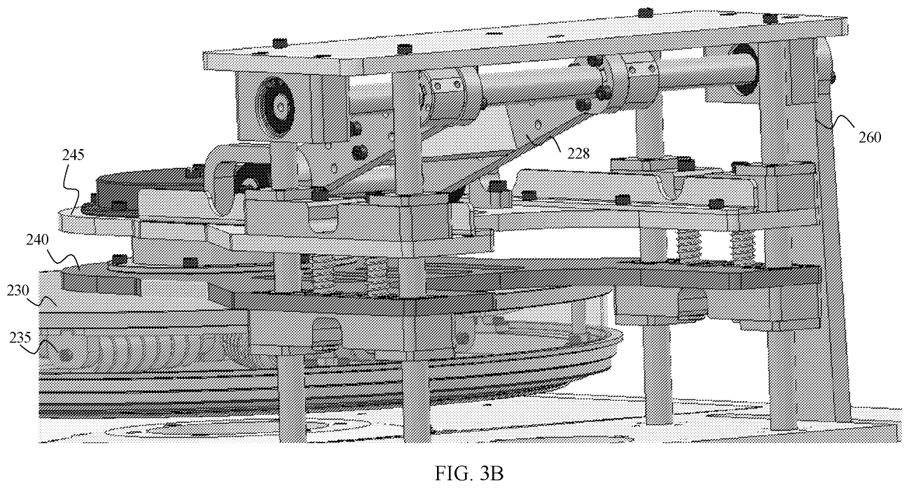

FIG. 3A shows a dough stretching machine with the plates and housing in an upward position, according to exemplary embodiments of the subject matter. In the upward position, the upper plate 245 and the lower plate 240 are relatively distanced from the baking dish 215. The upward position may be defined as a position in which the housing 230 cannot move rotationally when the baking dish 215 rotates.

The stretching machine may also comprise stabilizers 310, 312, 315, 318, on which the upper plate 245 and the lower plate 240 slide when the upper plate 245 and the lower plate 240 move upwards and downwards, as downwards is defined as moving towards the baking dish 215. In some cases, moving from the upward position to a downward position may be done by activating the piston module.

FIG. 3A also shows a top plate 330 used to protect the machine's component, or as a base when placing another stretching machine on top of the stretching machine, for example as multiple stretching machines stacked one on top of the other. The multiple stretching machines may be used with baking dishes having different sizes and/or forms, based on dishes suggested by the restaurant.

FIG. 3A also shows a plate axis 280 coupled to the operating rod 260, such that when the operating rod 260 moves, the plate axis 280 rotates, moving the upper plate 245 upwards or downwards, accordingly.

FIG. 3B shows a dough stretching machine with the plates and housing in a downward position, according to exemplary embodiments of the subject matter. In the downward position, the upper plate 245 and the lower plate 240 are relatively close to the baking dish 215. The upward position may be defined as a position in which the housing 230 moves rotationally when the baking dish 215 rotates.

In the downward position, the plate rod 285 moves rotationally relative to the plate axis 280, pushing the plates 245, and 240 towards the baking dish 215.

FIGS. 4A-4B show the plate rod pushing the upper plate to the downward position, according to exemplary embodiments of the subject matter. In FIG. 4A, the upper plate 245 and the lower plate 240 and the housing 230 are in the upward position. In the upward position, the plate rod 285 is substantially parallel to the upper plate 245 and there is room between the housing 230 and the baking dish 215.

In FIG. 4B, the upper plate 245, the lower plate 240, and the housing 230 are in the downward position. In the downward position, the distal end 420 of the plate rod 285 moves downwards due to the rotational movement of the plate axis 280. The distal end 420 of the plate rod 285 is secured to the upper plate 245, therefore pushing the upper plate downwards. The upper plate is coupled to the lower plate 240, for example using springs 270, so the lower plate 240 also moves downwards, along with the housing which is coupled to the lower plate 240. In the downward position, the housing 230 is in physical contact with the baking dish 215. In the downward position, the piston body 250, using the piston rod 252, pushes the operating rod 260, which in turn rotates the plate rod 285, moving the upper plate 245 downwards.

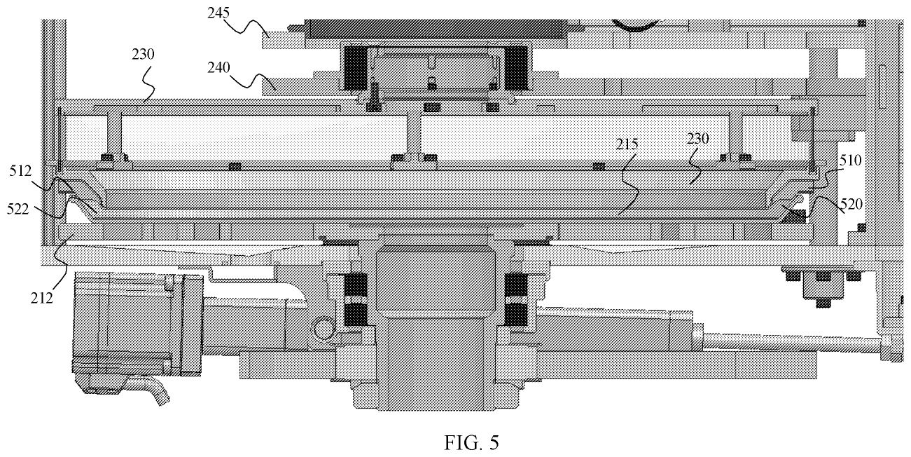

FIG. 5 shows the housing placed on top of the baking dish, according to exemplary embodiments of the subject matter. The housing 230 may be formed as a circle with an elastic layer filling at least a portion of the circle. The shape of the housing may be other than a circle, for example, an elliptical or polygonal shape. The shape of the housing may conform to the shape and size of the baking dish 215. The housing may comprise lips 510 located in the circumference area of the housing. The lips 510 are configured to be placed on top of the baking dish lips 520. This way, during the stretching process, the dough's stretching is limited and the dough cannot expand farther than the lips 510.

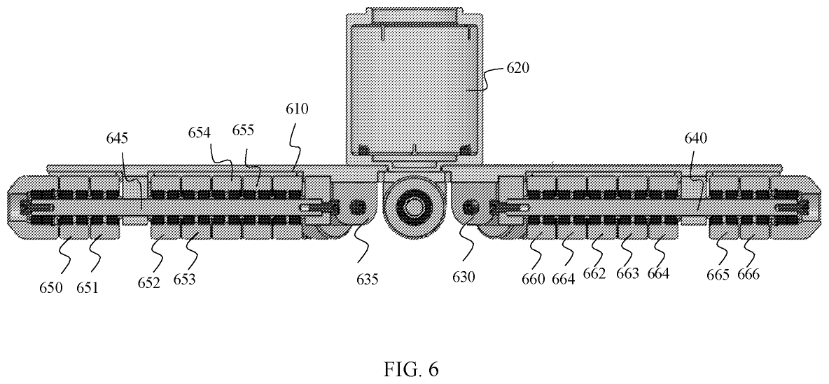

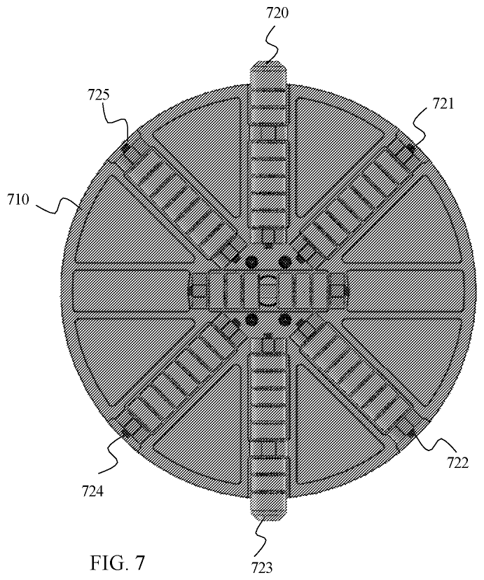

FIGS. 6-7 show rollers configured to roll above the dough, according to exemplary embodiments of the subject matter. The rollers are coupled to a roller plate that moves downwards, towards the dough, when initiating the stretching process. FIG. 6 shows a side view of the rollers and the components responsible for the rollers' functionality. The rollers may be coupled to the upper plate 245 of the stretching machine via rollers rod 620. The rollers rod 620 is coupled to a rollers plate 610 configured to carry the rollers. Multiple connectors such as connectors 630, 635, are coupled to the rollers plate 610. Pins 640, 645 extend from the connectors 630, 635, respectively, parallel to the plane of the rollers plate 610. The number of pins may vary according to the design of the machine. The rollers are ring-shaped objects slid on a pin of the one or more pins. For example, rollers 650, 651, 652, 653, 654 and 655 slide around pin 640 and rollers 660, 661, 662, 663, 664 and 665 slide around pin 645. The rollers move freely around the pins and are not coupled or connected to any motor, actuator, or motion generator that creates the rotational movement around the pins 640, 645. Only when the rollers are in a downward position, the rollers are in physical contact with a moving object, such as the dough, or a silicon sheet covering the dough, the rollers roll around the pins. The pins are affixed to the roller plate 610 which moves upwards and downwards according to a command, for example, based on the dough's height. This way, the rollers' center does not move relative to the pins and relative to the center of the roller plate 610 when the rollers roll. The rollers may move downwards during the stretching process, for example, due to the movement of the rollers pod.

FIG. 7 shows a bottom view of the rollers, in which six (6) pins 720, 721, 722, 723, 724 and 725 are coupled to the rollers plate 710.

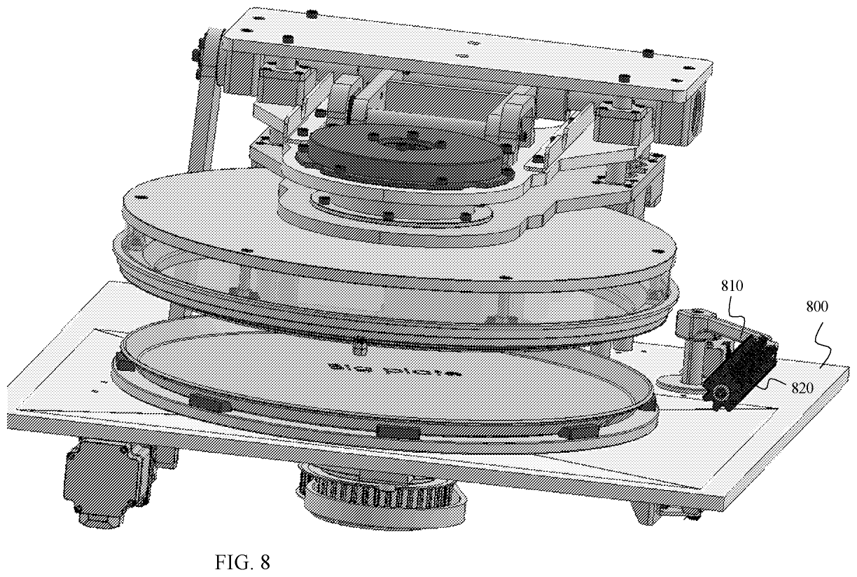

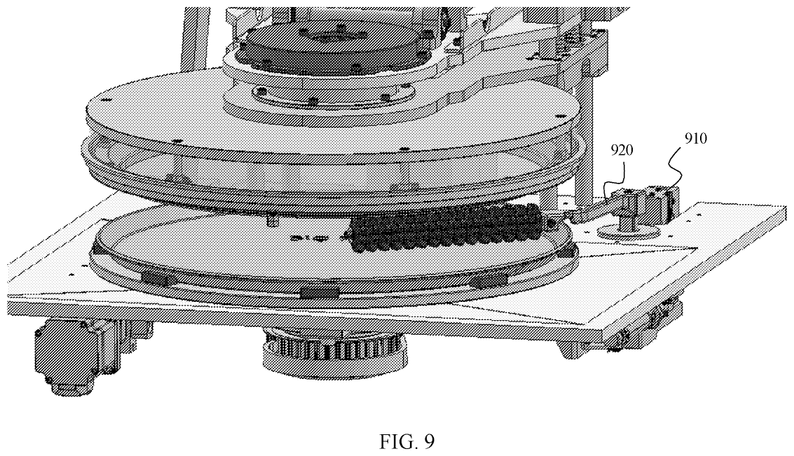

FIGS. 8-9 show the brushing mechanism, according to exemplary embodiments of the subject matter. The brushing mechanism is configured to create small holes in the dough after the stretching process, to prevent the dough from swelling after stretching. The brushing mechanism comprises a brush 820 and an arm 810 for moving the brush on the dough. The brush 820 comprises multiple bristles that create the holes in the dough. The robotic arm 810 first moves the brush 820 above the dough, then moves the brush 820 downwards, onto the dough. The dough may rotate during the brushing process, keeping the brush 820 moving upwards and downwards, or the dough may remain still, and the arm 810 will move the brush on the vertical axis to cover the area of the dough. In FIG. 8, the brushing mechanism is in a resting position, resting on a base plate 800. In FIG. 9, the brushing mechanism is in a working position, in which the brush 820 is placed above the baking dish area.

The brush 820 may have multiple sets of bristles, each set of bristles is coupled to a working rod moved by the arm 810. The sets of bristles may be coupled to different directions of the working rod, for example, an upper set, a bottom set, and two lateral sets, such that there is a 90 degrees angle between the sets of bristles, and the arm 810 may rotate the brush 820 on the dough.

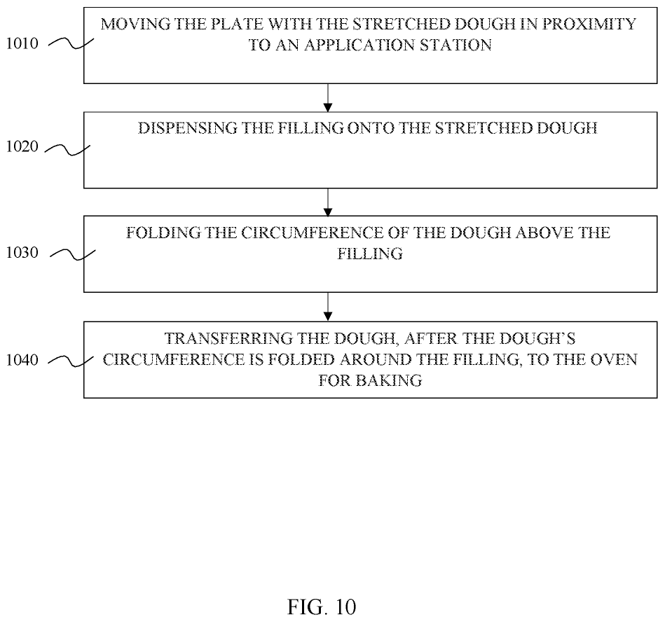

FIG. 10 shows a method for preparing pizza having a filled crust, according to exemplary embodiments of the subject matter.

Step 1000 discloses stretching the pizza dough or obtaining a stretched dough. Stretching may be performed manually or using a machine, such as the machine disclosed above or another machine. The stretched dough is placed on a plate. The plate used on the application station is wider than the plate used in the stretching machine, to enable some of the dough to expand further from the center of the plate, such that there is some dough that can be used to cover the crust's filling.

Step 1010 discloses moving the plate with the stretched dough in proximity to an application station. In some cases, this process is done by moving the elements of the application station to the plate that carries the stretched dough. The modules of the application station may include a container for storing the filling of the crust. The filling may be cheese, dressing, cookies, chopped vegetables, chopped meat, cream, or other edible food that can be placed on the dough. Another module of the application station may be a sensor, or multiple sensors, for monitoring the performance of the process, for example by capturing images that verify that the nozzle that outputs the filling dispenses an appropriate amount of filling and that the dispensing ends in due time, for example when the dough completes a 350 degrees circle and the like. Another component of the application station may be a motor and an axis for rotating the plate that carries the stretched dough when the filling is dispensed, such that the nozzle remains in place. In another exemplary embodiment, the nozzle is coupled to a robotic arm that moves the nozzle throughout the relevant areas on the dough, the areas to be covered with the filling.

Step 1020 discloses dispensing the filling onto the stretched dough. The dispensing may be done while moving the dough in a rotational movement, such that all the relevant areas in the dough are placed under the nozzle during the dispensing process. The speed of the rotational movement may be adjusted or controlled and should fit the rate of dispensing. The rate of dispensing may change according to the type of filling, for example, cream may be dispensed slower than cheese.

Step 1030 discloses folding the circumference of the dough above the filling. Folding may be done using a lifting arm being placed under a part of the dough's circumference, elevating this part and pushing it in the direction of the dough center. The lifting arm may be placed “outside” the circumference, away from the dough center, and have a movable fork for carrying and lifting the part of the circumference. The application station may also comprise a pusher module that pushes the lifted dough away from the dough center, to create a tube-like crust having the filling inside. The pusher module may be coupled to a robotic arm that moves the pusher module in accordance with the lifting arm's movement. That is, the lifting arm lifts part of the dough circumference and the pusher module pushes the lifted dough back towards the circumference.

Then, the dough rotates a little, for example, 3-5 degrees, and the lifting arm elevates the next part of the dough's circumference until reaching the end of the process, for example when lifting the entire dough's circumference, or 330 degrees of the part of the dough's circumference.

Step 1040 discloses transferring the dough, after the dough's circumference is folded around the filling, to the oven for baking.

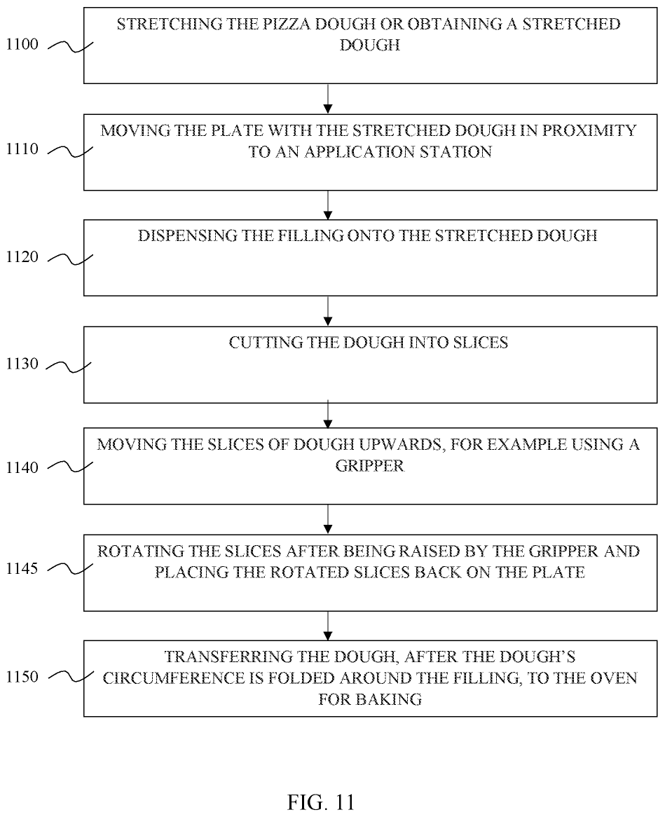

FIG. 11 shows a method for preparing a “cheesy bites” type of pizza, according to exemplary embodiments of the subject matter. The cheesy bites type of pizza is similar to classic pizza but instead of rolling out the pizza into one big pie, there are multiple little pies formed from the dough which are stuffed. The little pies may be in the form of balls, tubes, and the like.

Step 1100 discloses stretching the pizza dough or obtaining a stretched dough. Stretching may be performed manually or using a machine, such as the machine disclosed above or another machine. The stretched dough is placed on a plate.

Step 1110 discloses moving the plate with the stretched dough in proximity to an application station. In some cases, this process is done by moving the elements of the application station to the plate that carries the stretched dough. The modules of the application station may include a container for storing the filling of the crust, a knife for slicing the stretched dough, and a gripper for gripping slices of the stretched dough.

Step 1120 discloses dispensing the filling onto the stretched dough. The dispensing may be done while moving the dough in a rotational movement, such that all the relevant areas in the dough are placed under the nozzle during the dispensing process. The dispensing may be done in a continuous manner, for example consecutively until the desired area is covered with sufficient filling material, or in pulses, for example, one pulse, then rotate the plate carrying the stretched dough for a predefined number of degrees, then stop the rotation and dispense more filling material. The speed of the rotational movement may be adjusted or controlled and should fit the rate of dispensing. The rate of dispensing may change according to the type of filling, for example, cream may be dispensed slower than cheese.

Step 1130 discloses cutting the dough into slices. The cutting may be done at the circumference of the dough, for example, 3 centimeters from the circumference towards the center of the stretched dough. Cutting may involve moving the knife based on a stretching plan or based on commands from a management system of the machine. In some cases, the knife moves in the same area and the plate carrying the pizza rotates to bring new areas of the dough closer to the knife. In some other cases, the knife moves along the plate which does not rotate.

Step 1140 discloses moving the slices of dough upwards, for example using a gripper. The gripper may raise one slice or multiple slices together. When raising the slices, the slices may be detached from the rest of the dough, or still, be connected to the dough.

Step 1145 discloses rotating the slices after being raised by the gripper and placing the rotated slices back on the plate. Rotating may be in the range of 45-135 degrees around an imaginary axis that is perpendicular to the plate's plain.

Step 1150 discloses transferring the dough, after the dough's circumference is folded around the filling, to the oven for baking.

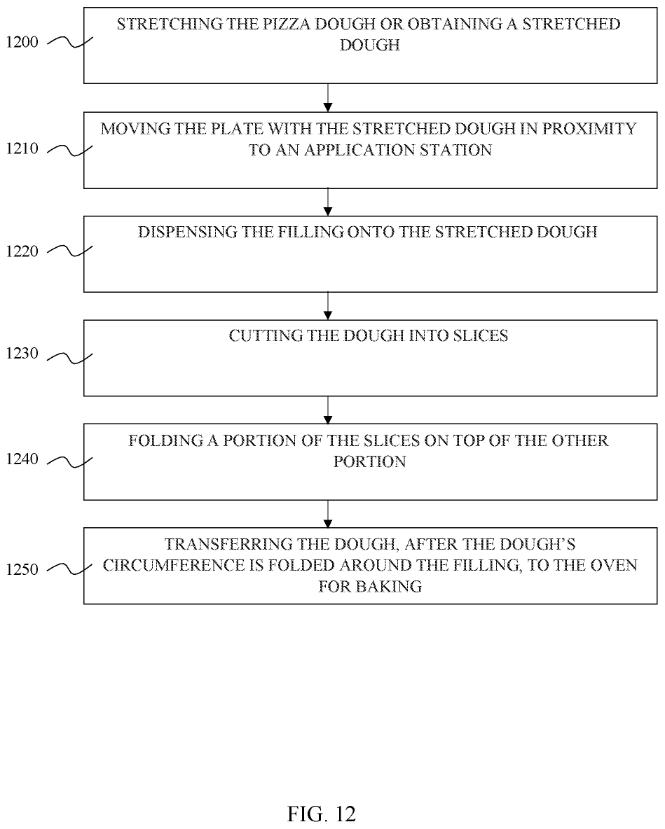

FIG. 12 shows a method for preparing a “crown” type of pizza, according to exemplary embodiments of the subject matter. A crown crust pizza is a pizza with pockets of ingredients baked into the crust.

Step 1200 discloses stretching the pizza dough or obtaining a stretched dough. Stretching may be performed manually or using a machine, such as a machine disclosed above or another machine. The stretched dough is placed on a plate.

Step 1210 discloses moving the plate with the stretched dough in proximity to an application station. In some cases, this process is done by moving the elements of the application station to the plate that carries the stretched dough. The modules of the application station may include a container for storing the filling of the crust, a knife for slicing the stretched dough and a gripper for gripping slices of the stretched dough.

Step 1220 discloses dispensing the filling onto the stretched dough. The dispensing may be done while moving the dough in a rotational movement, such that all the relevant areas in the dough are placed under the nozzle during the dispensing process. The dispensing may be done in pulses, for example, one pulse, then rotate the plate carrying the stretched dough for a predefined number of degrees, then stop the rotation and dispense more filling material. The speed of the rotational movement may be adjusted or controlled and should fit the rate of dispensing. The rate of dispensing may change according to the type of filling, for example, cream may be dispensed slower than cheese. Alternatively, the nozzle dispensing the filling may move to a desired location above the dough.

Step 1230 discloses cutting the dough into slices. The cutting may be done at the circumference of the dough, for example, 3 centimeters from the circumference towards the center of the stretched dough. Cutting may involve moving the knife based on a stretching plan or based on commands from a management system of the machine. The stretching plan may include rotation velocity or acceleration in various time durations of the plan, for example, 100 rounds per second in the first 5 seconds, then 12 rounds per second, then bring the plate closer to the roller housing, and the like. In some cases, the knife moves in the same area, and the plate carrying the pizza rotates to bring new areas of the dough closer to the knife. In some other cases, the knife moves along the plate which does not rotate.

Step 1240 discloses folding a portion of the slices on top of the other portion. For example, each slice has a first part covered with the filling and the second part is raised and folded on top of the first part. This process may be performed using a lifting arm, similar to the process of folding disclosed in step 1030.

Step 1250 discloses transferring the dough, after the dough's circumference is folded around the filling, to the oven for baking.

The processes, applications, and techniques disclosed above may also comprise dispensing oil onto the crust formed in the circumference of the dough. Dispensing the oil may be performed using a spray, or any other dispenser desired by a person skilled in the art.

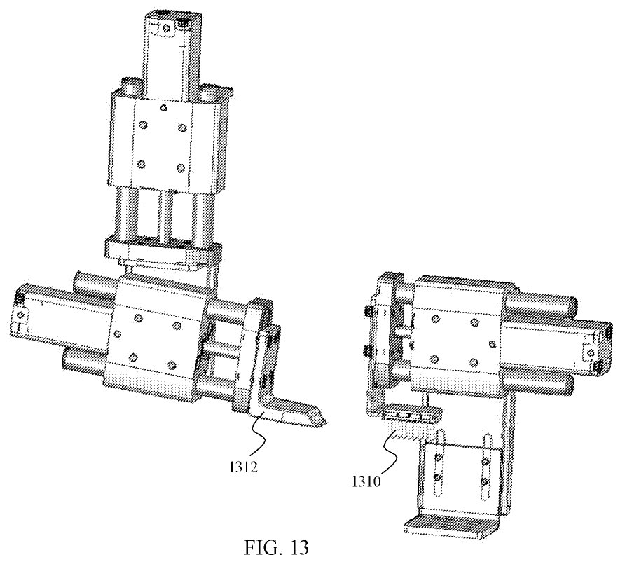

FIG. 13 shows mechanical components for preparing pizza having a filled crust, according to exemplary embodiments of the subject matter. The components comprise a brush shape or pulley system component 1310 configured to fold the external part of the dough towards the center of the dough and a pusher or pulley ruler module 1320 that pushes the lifted dough away from the dough center, to create a tube-like crust having the filling inside. Both the brush-shaped component 1310 and the pusher module 1320 may be movable and connected to robotic arms. The components may also include a dispenser for dispensing the filling.

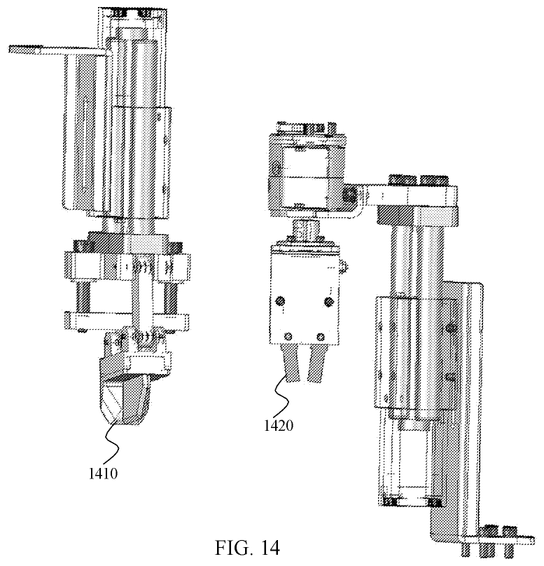

FIG. 14 shows mechanical components for preparing a “cheesy bites” type of pizza, according to exemplary embodiments of the subject matter. The components comprise a knife 1410 for cutting the dough into slices. The knife 1410 may be movable according to commands. The components comprise a gripper 1420 for gripping the sliced dough, and moving the sliced dough. The gripper may be movable and may comprise two gripping arms for holding the dough. The components may also include a dispenser for dispensing the filling.

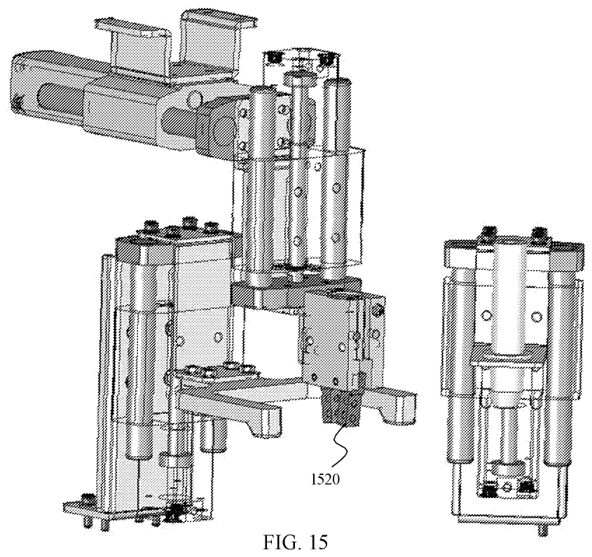

FIG. 15 shows mechanical components for preparing a “crown” type of pizza, according to exemplary embodiments of the subject matter. The components comprise a gripper and a dispenser for dispensing the filling. The filling for the crown type of pizza may vary according to requirements of customers.

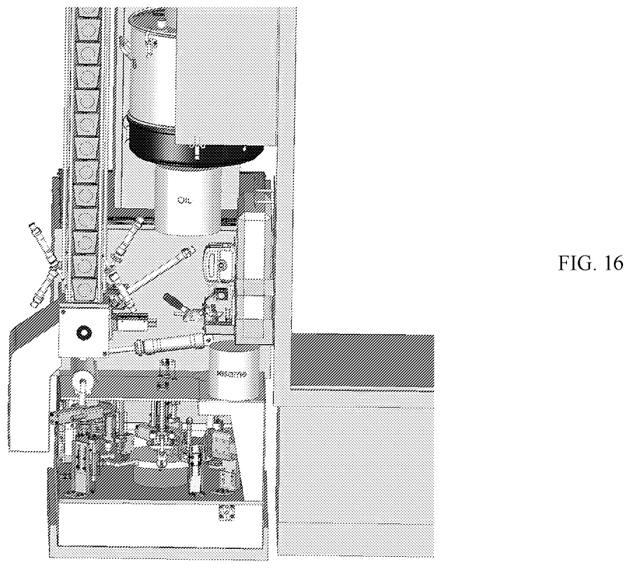

FIG. 16 shows a general structure for an application station for creating applications for pizza, according to exemplary embodiments of the subject matter. The application station comprises containers and dispensers for dispensing materials such as flour, oil, sesame, fillings, and the like. The dispensers are connected to a management system or a processor that controls the processes performed at the application station.

The application station also comprises a cheese dispenser for creating the cheese crust pizza. The cheese dispenser may contain cheese collected from cheese packages stacked above the dispenser. An arm may remove the packages and push the cheese into a tube coupled to the dispenser nozzle.

The application station may comprise a mechanical track or conveyor that enables transferring the dough from the stretching machine.

The stretching machine may comprise a cleaning module configured to clean the machine. The cleaning module may comprise a liquid container configured to store cleaning liquid, for example, a mix of soap and water, and a dispenser having a nozzle for dispensing the cleaning liquid. The cleaning module may output the cleaning module in response to a command, or in response to an indication from a sensor, for example, an indication that a stretching process ended.

The machine may comprise multiple application stations. Each station may be used to prepare one or more types of pizza. For example, a machine configured to prepare regular pizza dough and 3 additional pizza types may have 3 application stations, one for each additional type. In some other cases, a single application station may be used to prepare all 3 additional pizza types. The application stations will receive stretched dough from the stretching machine and will output pizza dough of unique shapes before transferring the dough to an oven. The application stations may comprise a rotating axis such that the plate rotates when placed in the application station. The application station comprises a dispenser for dispensing edible material, such as cream, cheese, chopped meat or vegetables, sauce and the like onto the pizza dough. The application station may comprise a folding unit for folding a circumference of the pizza dough. The application station may comprise a folding unit for folding a circumference of the pizza dough with the cheese in it. The application station may comprise a cutter and a robotic arm used to turn the cut dough for creating dough bits around the center of the pizza dough. The application stations may comprise one or more control arms and grippers for dough manipulation and crafting of the pizza dough. The application stations may comprise a holding mechanism to stabilize the baking tray of the pizza dough.

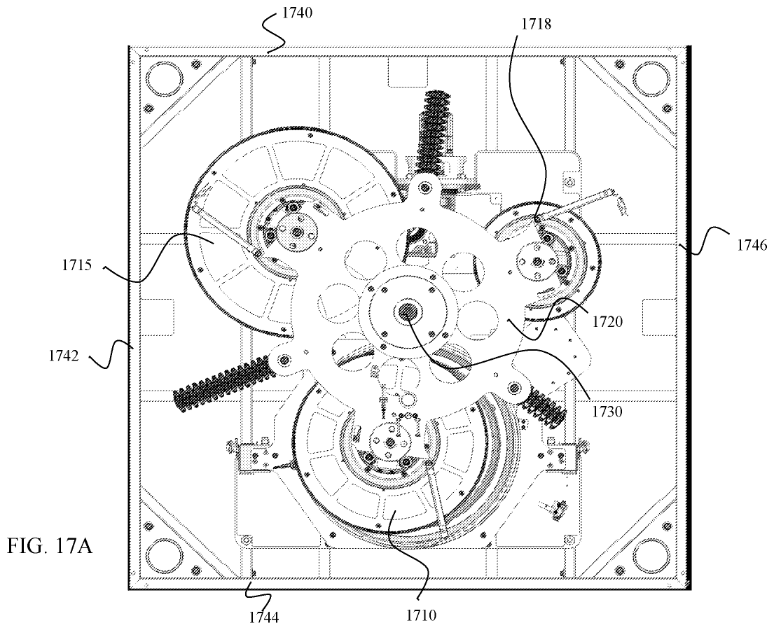

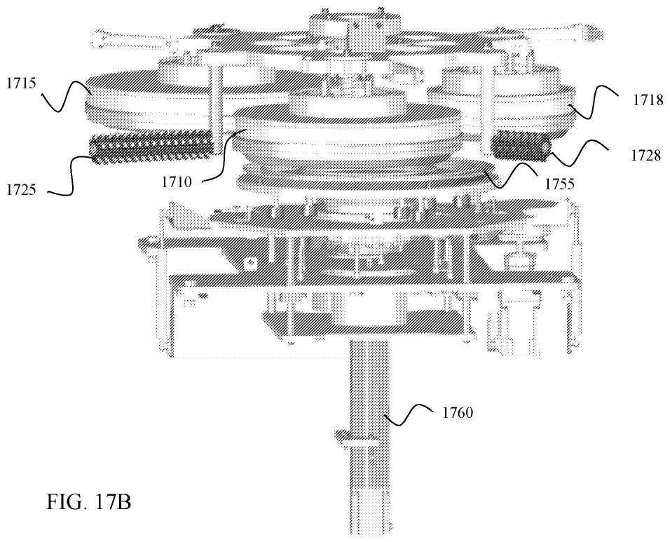

FIGS. 17A-17B show a machine for stretching pizza dough having multiple roller housings having different sizes, according to exemplary embodiments of the subject matter. The different sizes of the multiple roller housings enable the machine to use the relevant roller housing, with the size that fits the plate or the amount of pizza dough being stretched.

FIG. 17A shows a top view of the machine, with the roller housings 1710, 1715 and 1718. The roller housing 1718 is of a small size, roller housing 1710 is of a medium size, roller housing 1715 is of a large size. The roller housings 1710, 1715 and 1718 may rotate around an axis 1730. The roller housings 1710, 1715 and 1718 may be coupled to a rotating plate 1720 that moves around the axis 1730. Horizontal bars 1740, 1742, 1744, 1746 form the basis of the machine's body.

FIG. 17B shows a side view of the machine. It can be seen that the three roller housings 1710, 1715 and 1718 are generally at the same height. In some other cases, the roller housings are of different heights. In some cases, each roller housing may be coupled to a respective brush. Roller housing 1715 is coupled to brush 1725 and roller housing 1718 is coupled to brush 1728. FIG. 17B also shows the plate 1755 under the roller housings 1710, 1715 and 1718 and a vertical pole that functions as part of the machine's body, enabling the plate 1755 to be placed above the horizontal bars 1740, 1742, 1744, 1746. The number of roller housings and the shape and size of the roller housings may vary. The roller housings may be of a polygonal shape or elliptical shape if so desired.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A machine for stretching pizza dough, comprising:
a rotating tray configured to carry a plate with the pizza dough;
a roller housing located above the rotating tray, said roller housing is coupled to rollers, wherein the rollers roll when being in physical contact with the pizza dough;
a first actuator for rotating the rotating tray respective to the roller housing;
a second actuator for adjusting a vertical distance between the roller housing and the rotating tray;
a management system for controlling the operation of the first actuator and the second actuator according to a dough stretching plan.

2. The machine of claim 1, further comprises multiple roller housings having different sizes and a vertical axis, wherein the multiple roller housings are arranged around the vertical axis such that all the multiple roller housings can be placed above the rotating tray.

3. The machine of claim 1, further comprises a placing module configured to place the pizza dough in a center of the plate.

4. The machine of claim 1, wherein the roller housing comprises an elastic layer capable of being in physical contact with the pizza dough.

5. The machine of claim 3, wherein the placing module comprises movable rollers in a bottom part of the plate.

6. The machine of claim 1, wherein the roller housing has an upward position being remote from the rotating tray and a downward position in which the roller housing is in physical contact with the pizza dough.

7. The machine of claim 1, further comprises a flour container configured to store flour powder and a flour dispenser configured to dispense flour.

8. The machine of claim 1, further comprises a brushing mechanism configured to create holes in the pizza dough, said brushing mechanism comprises a brush and an arm configured to move the brush on the dough.

9. The machine of claim 1, wherein the rotating tray comprises multiple sets of movable pins, each set is arranged in a different area of the rotating tray, said multiple sets enable securing plates of multiple sizes on the rotating tray.

10. The machine of claim 1, further comprises an application station configured to prepare dough of unique shapes before transferring the dough to an oven.

11. The machine of claim 10, wherein the application station comprises a rotating axis such that the plate rotates when placed in the application station.

12. The machine of claim 10, wherein the application station comprises a dispenser for dispensing edible material onto the pizza dough.

13. The machine of claim 10, wherein the application station comprises a folding unit for folding a circumference of the pizza dough.

14. The machine of claim 10, wherein the application station comprises a folding unit for folding a circumference of the pizza dough with the cheese in it.

15. The machine of claim 10, wherein the application station comprises a cutter and a robotic arm used to turn the cut dough for creating dough bits around the center of the pizza dough.

16. The machine of claim 10, wherein the application station comprises multiple control arms and grippers for dough manipulation and crafting of the pizza dough.

17. The machine of claim 10, wherein the application station comprises a holding mechanism to stabilize the baking tray of the pizza dough.
